(19) United States
(12) Patent Application Publication
(10) Pub. No.: US 2024/0223301 A1
(43) Pub. Date: Jul. 4, 2024

(54) SYSTEMS AND METHODS FOR ADAPTIVE RACH FLOW OPTIMIZATION

(71) Applicant: RAKUTEN MOBILE, INC., Tokyo (JP)

(72) Inventor: Sandeep Mani TRIPATHI, Tokyo (JP)

(73) Assignee: RAKUTEN MOBILE, INC., Tokyo (JP)

(21) Appl. No.: 17/910,019

(22) PCT Filed: Aug. 8, 2022
(86) PCT No.: PCT/US2022/039686

§ 371 Date: Sep. 8, 2022

(51) Int. Cl. H04L 1/00; H04W 76/10

(52) U.S. Cl. CPC H04L 1/0009; H04W 76/10

(57) ABSTRACT

A method for adaptively optimizing a contention resolution (CR) message by a radio access network (RAN) node includes: receiving a plurality of radio resource control (RRC) connection request messages from a plurality of first user equipment (UE), sending a plurality of CR messages using a first code rate to the plurality of first UE, in response to receiving the plurality of RRC connection request messages from the plurality of first UE, and updating one or more parameters to adjust the first code rate to a second code rate, based on a success rate corresponding to the plurality of CR messages using the first code rate. The method further includes generating a CR message using the second code rate and sending the CR message using the second code rate to a second UE.

### 1. FIELD

Apparatuses and methods consistent with example embodiments of the present disclosure relate to adaptively optimizing a RACH flow by a radio access network (RAN) node, and in particular, adaptively optimizing a contention resolution (CR) message of the RACH flow.

### 2. DESCRIPTION OF RELATED ART

In related art telecommunications standards (e.g., 3GPP specifications for LTE, 5G, etc.), in order for a user equipment (UE) to acquire uplink synchronization and obtain a specified ID for radio access communication, an initial access sequence (e.g., RACH flow) is performed between the UE and a radio access network (RAN) node (e.g., gNB). The initial access sequence typically involves the UE transmitting a first message (e.g., random access channel (RACH) message) to the node. In response to the first message from the UE, the node may send a second message (e.g., RAR message) to the UE. In response to the second message from the node, the UE may send a third message (e.g., a radio resource control (RRC) connection request) to the node. In response to the third message from the UE, the node may send a fourth message (e.g., RRC connection setup) to the UE. In response to the fourth message from the node, the UE may send an acknowledgment message (e.g., RRC setup complete) to the node. During the initial access sequence, the RRC connection setup message (fourth message) is sent using a predetermined code rate. The node may use a modulation and coding scheme (MCS) and a number of physical resource blocks (PRBs) corresponding to the predetermined code rate when sending the RRC connection setup message to the UE. The initial access sequence may be performed between the node and each UE in a cell serviced by the node. However, even if a radio frequency condition of an environment may support a higher code rate, or if the radio frequency condition of the environment only supports a lower code rate, the code rate used by the node for the RRC connection setup message disadvantageously remains the same.

### SUMMARY

According to embodiments, systems and methods are provided for a system to enable adaptively varying a code rate used to send a contention resolution (CR) message based on cell statistics over a period of time.

According to aspects of one or more example embodiments, a method for adaptively optimizing a contention resolution (CR) message by a radio access network (RAN) node is provided. The method may include receiving a plurality of radio resource control (RRC) connection request messages from a plurality of first user equipment (UE), sending a plurality of CR messages using a first code rate to the plurality of first UE, in response to receiving the plurality of RRC connection request messages from the plurality of first UE, and updating one or more parameters to adjust the first code rate to a second code rate, based on a success rate corresponding to the plurality of CR messages using the first code rate. Each of the plurality of RRC connection request messages may be received from a respective one of the plurality of first UE, and each of the plurality of CR messages may be sent to a respective one of the plurality of first UE. The method may include generating a CR message using the second code rate, and using the second code rate to a second UE.

The plurality of RRC connection request messages from the plurality of first UE may be received over a threshold time window, and the CR message using the second code rate may be generated in response to receiving a RRC connection request message from the second UE after the threshold time window.

The method for updating the one or more parameters to adjust the first code rate to the second code rate based on the success rate corresponding to the plurality of CR messages using the first code rate may further include receiving one or more acknowledgement messages, determining the success rate corresponding to the plurality of CR messages using the first code rate based on a ratio of a number of the one or more acknowledgement messages received to a number of the plurality of RRC connection request messages received from the plurality of first UE, and updating the one or more parameters to adjust the first code rate to the second code rate based on the determined success rate. Each acknowledgement message may be received from a UE among the plurality of first UE in response to the UE receiving a respective one of the plurality of CR messages using the first code rate.

The method for updating the one or more parameters to adjust the first code rate to the second code rate based on the determined success rate may further include determining whether the number of the plurality of RRC connection request messages received from the plurality of first UE is greater than a first threshold value, updating the one or more parameters to decrease the first code rate to the second code rate if the number of the plurality of RRC connection request messages received from the plurality of first UE is greater than the first threshold value and the determined success rate is less than a lower threshold success rate. The first code rate may be decreased by a code rate decrease threshold amount.

The method for updating the one or more parameters to adjust the first code rate to the second code rate based on the determined success rate may further include determining whether the number of the plurality of RRC connection request messages received from the plurality of first UE is greater than a second threshold value, and updating the one or more parameters to increase the first code rate to the second code rate if the number of the plurality of RRC connection request messages received from the plurality of first UE is greater than a second threshold value and if the determined success rate is greater than an upper threshold success rate. The first code rate may be increased by a code rate increase threshold amount.

According to aspects of one or more example embodiments, an apparatus for performing adaptive optimization of a contention resolution (CR) message by a radio access network (RAN) node may be provided. The apparatus may include a memory storing instructions, and at least one processor configured to execute the instructions to receive a plurality of radio resource control (RRC) connection request messages from a plurality of first user equipment (UE), send a plurality of CR messages using a first code rate to the plurality of first UE, in response to receiving the plurality of RRC connection request messages from the plurality of first UE, and update one or more parameters to adjust the first code rate to a second code rate, based on a success rate corresponding to the plurality of CR messages using the first code rate. Each of the plurality of RRC connection request messages may be received from a respective one of the plurality of first UE, and each of the plurality of CR messages may be sent to a respective one of the plurality of first UE. The apparatus may further include instructions to generate a CR message using the second code rate, and send the CR message using the second code rate to a second UE.

The instructions to update the one or more parameters to adjust the first code rate to the second code rate based on the success rate corresponding to the plurality of CR messages using the first code rate further comprise instructions to receive one or more acknowledgement messages, each acknowledgement message being received from a UE among the plurality of first UE in response to the UE receiving a respective one of the plurality of CR messages using the first code rate, determine the success rate corresponding to the plurality of CR messages using the first code rate based on a ratio of a number of the one or more acknowledgement messages received to a number of the plurality of RRC connection request messages received from the plurality of first UE, and update the one or more parameters to adjust the first code rate to the second code rate based on the determined success rate.

The instructions to update the one or more parameters to adjust the first code rate to the second code rate based on the determined success rate further comprise instructions to determine whether the number of the plurality of RRC connection request messages received from the plurality of first UE is greater than a first threshold value, and update the one or more parameters to decrease the first code rate to the second code rate if the number of the plurality of RRC connection request messages received from the plurality of first UE is greater than the first threshold value and the determined success rate is less than a lower threshold success rate.

The instructions to update the one or more parameters to adjust the first code rate to the second code rate based on the determined success rate further comprise instructions to determine whether the number of the plurality of RRC connection request messages received from the plurality of first UE is greater than a second threshold value, and update the one or more parameters to increase the first code rate to the second code rate if the number of the plurality of RRC connection request messages received from the plurality of first UE is greater than a second threshold value and if the determined success rate is greater than an upper threshold success rate. The first code rate may be decreased by a code rate decrease threshold amount, and the first code rate may be increased by a code rate increase threshold amount.

The plurality of RRC connection request messages from the plurality of first UE may be received over a threshold time window, and the CR message using the second code rate may be generated in response to receiving a RRC connection request message from the second UE after the threshold time window.

According to aspects of one or more example embodiments, a non-transitory computer-readable medium for storing computer readable program code or instructions for carrying out operations for adaptive optimization of a contention resolution (CR) message when executed by a processor may be provided. The operations may include receiving a plurality of radio resource control (RRC) connection request messages from a plurality of first user equipment (UE), sending a plurality of CR messages using a first code rate to the plurality of first UE, in response to receiving the plurality of RRC connection request messages from the plurality of first UE, and updating one or more parameters to adjust the first code rate to a second code rate, based on a success rate corresponding to the plurality of CR messages using the first code rate. Each of the plurality of RRC connection request messages may be received from a respective one of the plurality of first UE, and each of the plurality of CR messages may be sent to a respective one of the plurality of first UE. The operations may further include generating a CR message using the second code rate, and sending the CR message using the second code rate to a second UE.

The plurality of RRC connection request messages from the plurality of first UE are received over a threshold time window, and the CR message using the second code rate may be generated in response to receiving a RRC connection request message from the second UE after the threshold time window.

The operation of updating the one or more parameters to adjust the first code rate to the second code rate based on the success rate corresponding to the plurality of CR messages using the first code rate may further include operations for receiving one or more acknowledgement messages, each acknowledgement message being received from a UE among the plurality of first UE in response to the UE receiving a respective one of the plurality of CR messages using the first code rate, determining the success rate corresponding to the plurality of CR messages using the first code rate based on a ratio of a number of the one or more acknowledgement messages received to a number of the plurality of RRC connection request messages received from the plurality of first UE, and updating the one or more parameters to adjust the first code rate to the second code rate based on the determined success rate.

The operation for updating the one or more parameters to adjust the first code rate to the second code rate based on the determined success rate may further include operations for determining whether the number of the plurality of RRC connection request messages received from the plurality of first UE is greater than a first threshold value, and updating the one or more parameters to decrease the first code rate to the second code rate if the number of the plurality of RRC connection request messages received from the plurality of first UE is greater than the first threshold value and the determined success rate is less than a lower threshold success rate.

The operations for updating the one or more parameters to adjust the first code rate to the second code rate based on the determined success rate may further include operations for determining whether the number of the plurality of RRC connection request messages received from the plurality of first UE is greater than a second threshold value, and updating the one or more parameters to increase the first code rate to the second code rate if the number of the plurality of RRC connection request messages received from the plurality of first UE is greater than a second threshold value and if the determined success rate is greater than an upper threshold success rate.

The non-transitory computer-readable medium for storing computer readable program code or instructions for carrying out operations may further include instructions for carrying out operations for generating a plurality of CR messages using the second code rate, and sending the plurality of CR message using the second code rate to a plurality of second UE, wherein each of the plurality of CR messages using the second code rate may be sent to a respective one of the plurality of second UE.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIG. 1 illustrates an initial access sequence between a base station and a user equipment (UE), in accordance with one or more example embodiments;

FIG. 2 illustrates a flowchart of a method for performing adaptive optimization of a contention resolution (CR) message, in accordance with one or more example embodiments;

FIG. 3 illustrates a flowchart of a method for performing adaptive optimization of a contention resolution (CR) message, in accordance with one or more example embodiments; and

FIG. 4 illustrates a diagram of components of one or more devices, in accordance with one or more example embodiments.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

As set forth above, the related art initial access sequence relies on static parameters that specify a code rate for a Radio Resource Control (RRC) connection setup message used in communication between a base station and a user equipment (UE). However, even if a radio frequency condition of an environment may support a higher code rate, or if the radio frequency condition may only support a lower code rate, the code rate determined by the base station for the second message remains the same.

Example embodiments provide a system and method that adaptively optimize a RRC connection setup message. For instance, a radio access network (RAN) node (e.g., gNB) may determine a success rate corresponding to a plurality of RRC connection setup messages sent to a plurality of UE in a cell serviced by the node. The node may determine a radio frequency condition of an environment between the base station and the plurality of UE based on the success rate. If the success rate is high, then the node may determine that the radio frequency condition is good and may support a higher code rate, and thus, the node may update the one or more parameters to increase the code rate for future RRC connection setup messages. If the success rate is low, then the node may determine that the radio frequency condition is poor and may support a lower code rate, and thus, the node may update the one or more parameters to decrease the code rate for future RRC connection setup messages.

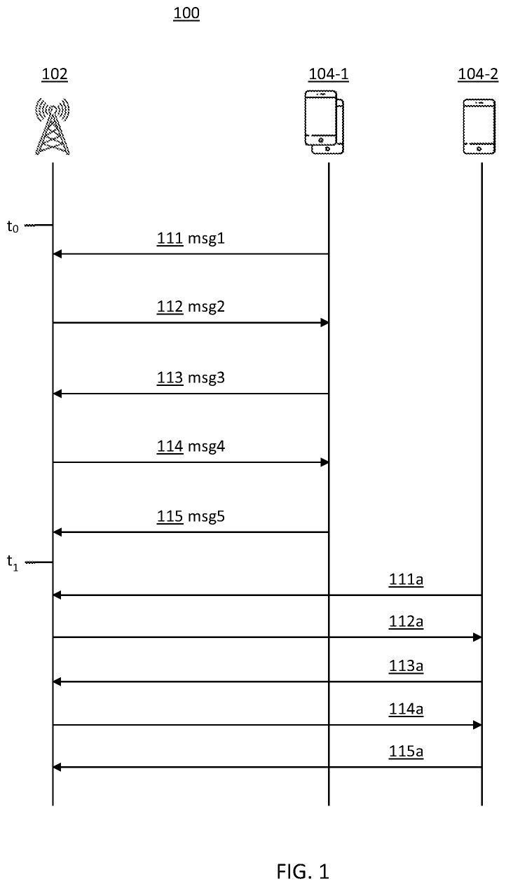

FIG. 1 illustrates an initial access sequence between a RAN node and a UE, in accordance with one or more example embodiments. Referring to FIG. 1, a RAN node 102 (e.g., gNB), a plurality of UE 104-1, and one or more UE 104-2 may operate in an environment 100. The UE 104-1 (e.g., a UE among the plurality of UE 104-1) may start the initial access sequence with the node 102 during a threshold time window, which may be defined as the time between time t₀ and time t₁. To start the initial access sequence, the UE 104-1 may send a first message 111 (“msg1”) to the node 102. For example, the UE 104-1 may send a random access channel (RACH) message as the first message 111.

The node 102 may generate a second message 112 (“msg2”) in response to receiving the first message 111 from the UE 104-1, and send the second message 112 to the UE 104-1. For example, the node 102 may generate a random access response (RAR) message as the second message 112.

The UE 104-1 may generate a third message 113 (“msg3”) in response to receiving the second message 112 from the node 102, and send the third message 113 to the node 102. For example, the UE 104-1 may generate a RRC connection request message as the third message 113.

The node 102 may generate a fourth message 114 (“msg4”) in response to receiving the third message 113 from the UE 104-1, and send the fourth message 114 to the UE 104-1. For example, if the node 102 successfully receives and decodes the third message 113, then the node 102 may generate a contention resolution (CR) message as the fourth message 114. The node 102 may generate the fourth message 114 using a modulation and coding scheme (MCS) and a number of physical resource blocks (PRBs) corresponding to a predetermined code rate for the fourth message 114. The predetermined code rate may be an initial code rate, or may be a code rate subsequently determined by the node 102.

The UE 104-1 may generate a fifth message 115 (“msg5”) in response to receiving the fourth message 114 from the node 102, and may send the fifth message 115 to the node 102. For example, if the UE 104-1 successfully receives and decodes the fourth message 114, then the UE 104-1 may generate an acknowledgement message as the fifth message 115. The fifth message 115 may indicate receipt of the fourth message 114 by the UE 104-1. The fifth message 115 may be a RRC setup complete message.

The node 102 may determine that the UE 104-1 successfully received the fourth message 114 in response to receiving the fifth message 115 from the UE 104-1, and that the initial access sequence with the UE 104-1 is complete.

Each UE among the plurality of UE 104-1 may each start the initial access sequence with the node 102 during the threshold time window. For example, the plurality of UE 104-1 may include a first UE and a second UE. The first UE among the plurality of UE 104-1 may send a first message 111 to the node 102 at a time during the threshold time window, and the second UE among the plurality of UE 104-1 may also send a first message 111 to the node 102 at the same time or at a different time during the threshold time window. In response to receiving the first message 111 from the first UE, the node 102 may generate and send a second message 112 to the first UE; and in response to receiving the first message 111 from the second UE, the node 102 may generate and send a second message 112 to the second UE. In response to the first UE receiving the second message 112 from the node 102, the first UE may generate and send a third message 113 to the node 102; and in response to the second UE receiving the second message 112 from the node 102, the second UE may generate and send a third message 113 to the node 102. In response to receiving the node 102 receiving the third message 113 from the first UE, the node 102 may generate and send a fourth message 114 to the first UE; and in response to the node 102 receiving the third message 113 from the second UE, the node 102 may generate and send da fourth message 114 to the second UE. In response to the first UE receiving the fourth message 114 from the node 102, the first UE may generate and send a fifth message 115 to the node 102; and in response to the second UE receiving the fourth message 114 from the node 102, the second UE may generate and send a fifth message 115 to the node 102.

FIG. 1 shows the threshold time window extending from before the node 102 receives the first message 111 from the UE 104-1 until after the node 102 receives the fifth message 115 from the UE 104-1, however the threshold time window is not limited thereto. For example, the threshold time window may be shorter (e.g., between t₀ and a time before t₁) or the threshold time window may be longer (e.g., between t₀ and a time after t_{L}) so long as the threshold time window is sufficient to receive a plurality of first messages 112 from the plurality of UE 104-1. In some implementations, the threshold time window may be sufficient to receive a plurality of third messages 113 from the plurality UE 104-1.

The node 102 may determine a success rate corresponding to a plurality of fourth messages 114 sent to the UE 104-1. The node 102 may determine the success rate based on a number of third messages 113 received from the UE 104-1, and a number of fourth messages 114 successfully received by the UE 104-1. For example, the node 102 may increment a first counter in response to receiving a third message 113 from a first UE among the UE 104-1, and increment the first counter in response to receiving a third message 113 from a second UE among the UE 104-1. Likewise, the node 102 may increment a second counter in response to receiving a fifth message 115 from the first UE, and increment the second counter in response to receiving a fifth message 115 from the second UE. The first counter may indicate the number of third messages 113 received from the UE 104-1, and the second counter may indicate the number of fourth messages 114 successfully received by the UE 104-1. The node 102 may determine the success rate corresponding to the plurality of fourth messages 114 based on a ratio of the number of fourth messages 114 successfully received by the UE 104-1 (second counter) to the number of third messages 113 received from the UE 104-1 (first counter).

In some implementations, the node 102 may instead increment the first counter in response to sending a fourth message 114 to the UE 104-1, and the node 102 may determine the success rate based on a ratio of the number of fifth messages 115 received (second counter) to the number of fourth messages 114 sent (first counter).

The node 102 may update one or more parameters to adjust a code rate for the fourth message 114 based on the determined success rate. For example, the node 102 may determine if the success rate corresponding to the plurality of fourth messages 114 sent to the UE 104-1 is less than a first threshold value or greater than a second threshold value. If the success rate is less than the first threshold value, then the node 102 may adjust the parameters to decrease the code rate. For example, the node 102 may decrease the code rate based on a code rate decrease threshold value indicating a number of steps to decrease the code rate. If the success rate is greater than the second threshold value, then the node 102 may adjust the parameters to increase the code rate. For example, the node 102 may increase the code rate based on a code rate increase threshold value indicating a number of steps to increase the code rate.

Referring to FIG. 1, the UE 104-2 (e.g., a UE among the one or more UE 104-2) may start the initial access sequence with the node 102 after the threshold time window (e.g., after time t₁). To start the initial access sequence, the UE 104-2 may send a first message 111a to the node 102. For example, the UE 104-2 may send a random access channel (RACH) message as the first message 111a.

The node 102 may generate a second message 112a in response to receiving the first message 111a from the UE 104-2, and send the second message 112a to the UE 104-2. For example, the node 102 may generate a random access response (RAR) message as the second message 112a.

The UE 104-2 may generate a third message 113a in response to receiving the second message 112a from the node 102, and send the third message 113a to the node 102. For example, the UE 104-2 may generate a RRC connection request message as the third message 113a.

The node 102 may generate a fourth message 114a in response to receiving the third message 113a from the UE 104-2, and send the fourth message 114a to the UE 104-2. For example, the node 102 may generate a RRC connection setup message as the fourth message 114a. The node 102 may generate the fourth message 114a using a modulation and coding scheme (MCS) and a number of physical resource blocks (PRBs) corresponding to an adjusted code rate. For example, the node 102 may generate the fourth message 114a using a MCS and a number of PRBs corresponding to a code rate that is adjusted based on communication between the node 102 and the UE 104-1 (e.g., based on the success rate corresponding to the plurality of fourth messages 114 sent by the node 102 to the plurality of UE 104-1).

The UE 104-2 may generate a fifth message 115a in response to receiving the fourth message 114a from the node 102, and send the fifth message 115a to the node 102. For example, the UE 104-2 may generate an acknowledgement message as the fifth message 115a. The fifth message 115a may indicate receipt of the fourth message 114a by the UE 104-2. The fifth message 115a may be a RRC setup complete message.

The node 102 may determine that the UE 104-2 successfully received the fourth message 114a in response to receiving the fifth message 115a from the UE 104-2, and that the initial access sequence with the UE 104-2 is complete.

Each of the one or more UE 104-2 may each start the initial access sequence with the node 102 after the threshold time window. For example, the one or more UE 104-2 may include only a first UE. The first UE among the one or more UE 104-2 may send a first message 111a to the node 102 at a time after t₁. As another example, the one or more UE 104-2 may include a first UE and a second UE. The first UE among the one or more UE 104-2 may send a first message 111a to the node 102 at a time after t₁, and the second UE among the one or more UE 104-2 may send a first message 111a to the node 102 at the same time or at a different time after t₁.

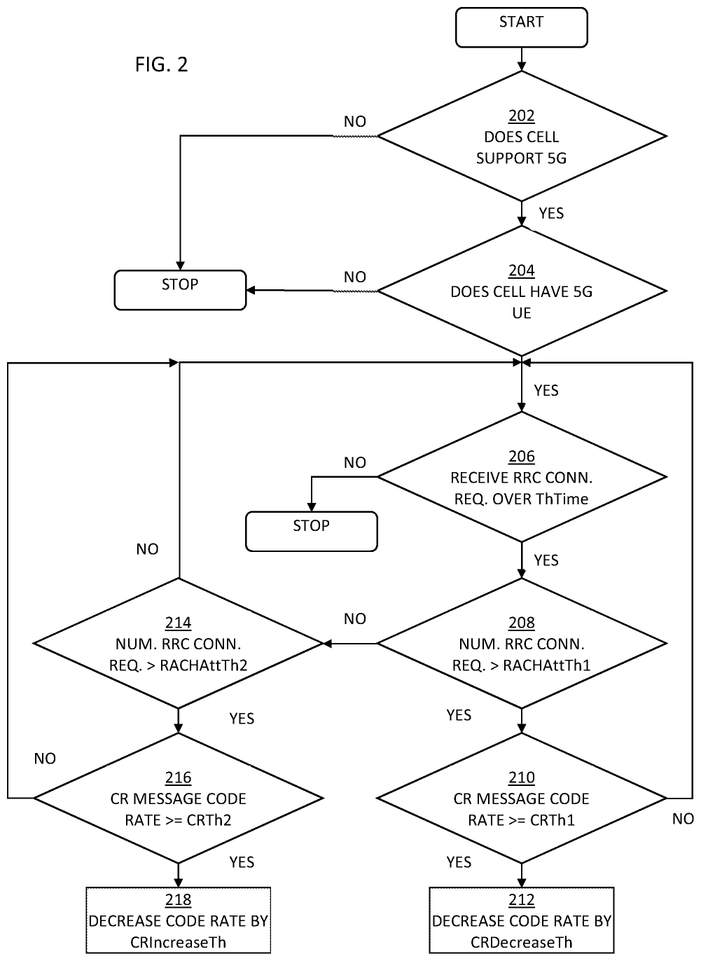

FIG. 2 illustrates a flowchart of a method for adjusting a code rate, in accordance with one or more example embodiments. Referring to FIG. 2, at operation 202, the node 102 may determine if it services a cell supporting 5G. If the node 102 determines that the cell does not support 5G, then the node 202 proceeds to stop. If the node 102 determines that the cell supports 5G, then the node 202 proceeds to operation 204.

In some implementations, at operation 202, the node 102 determines if it services a cell supporting 5G or LTE. If the node 102 determines that the cell does not support 5G or LTE, then the node 202 proceeds to stop. If the node 102 determines that the cell supports 5G or LTE, then the node 202 proceeds to operation 204.

At operation 204, in some implementations, the node 102 determines if the cell includes one or more UE among the plurality of UE 104-1 that supports 5G. If the node 102 determines that the cell does not include a UE among the plurality of UE 104-1 that support 5G, then the node 102 proceeds to stop. If the node 102 determines that the cell includes a UE among the plurality of UE 104-1 that support 5G, then the node 102 proceeds to operation 206.

In some implementations, at operation 204, the node 102 determines if the cell includes one or more UE among the plurality of UE 104-1 that supports 5G or LTE. If the node 102 determines that the cell does not include a UE among the plurality of UE 104-1 that support 5G or LTE, then the node 102 proceeds to stop. If the node 102 determines that the cell includes a UE among the plurality of UE 104-1 that support 5G or LTE, then the node 102 proceeds to operation 206.

At operation 206, in some implementations, the node 102 determines if the node 102 has received one or more third messages 113 (e.g., RRC connection request messages) during a threshold time window ThTime. The threshold time window ThTime may be, for example 2 hours (t₁−t₀=2 hours), 4 hours (t₁−t₀=4 hours), 24 hours (t₁−t₀=24 hours), or any other specified duration. If the node 102 determines that no third messages 113 were received over ThTime, then the node 102 proceeds to stop. If the node 102 determines that a third message 113 was received from the UE 104-1 (e.g., from a UE among the plurality of UE 104-1) over ThTime, then the node 102 proceeds to operation 208.

In some implementations, at operation 206, the node 102 determines if the node 102 has received one or more first messages 113 (e.g., initial access request message, RACH message) during the threshold time window ThTime. If the node 012 determines that no first messages 111 were received over ThTime, then the node 102 proceeds to stop. If the node 102 determines that a first message 111 was received from the UE 104-1 over ThTime, then the node 102 proceeds to operation 208.

At operation 208, in some implementations, the node 102 determines if the number of third messages 113 received over ThTime is greater than a first threshold value RACHAttTh1, and if a success rate corresponding to a plurality of fourth messages 114 is less than or equal to a lower threshold success rate Xlow. The first threshold value RACHAttTh1 may specify a minimum number of initial access connection attempts to ensure a sufficient sample size for adjusting the fourth message 114 code rate. For example, the first threshold value may be 500. If the node 102 determines that the number of third messages 113 received is less than or equal to RACHAttTh1 or if the fourth message 114 success rate is greater than Xlow, then the node 102 proceeds to operation 214. If the node 102 determines that the number of third messages 113 received is greater than RACHAttTh1 and the fourth message 114 success rate is less than or equal to Xlow, then the node 102 proceeds to operation 210.

In some implementations, at operation 208, the node 102 determines if the number of first messages 111 received over ThTime is greater than a first threshold value RACHAttTh1, and if a success rate corresponding to a plurality of fourth messages 114 is less than or equal to a lower threshold success rate Xlow. The first threshold value RACHAttTh1 may specify a minimum number of initial access connection attempts to ensure a sufficient sample size for adjusting the fourth message 114 code rate. For example, the first threshold value may be 500. If the node 102 determines that the number of first messages 111 received is less than or equal to RACHAttTh1 or if the fourth message 114 success rate is greater than Xlow, then the node 102 proceeds to operation 214. If the node 102 determines that the number of first messages 111 received is greater than RACHAttTh1 and the fourth message 114 success rate is less than or equal to Xlow, then the node 102 proceeds to operation 210.

At operation 210, in some implementations, the node 102 determines if a current code rate being used by the node 102 for a fourth message 114 is greater than or equal to a minimum code rate CRTh1. If the node 102 determines that the current code rate being used is less than CRTh1, then the node 102 proceeds to operation 206. In some implementations, if the node 102 determines that the current code rate being used is less than CRTh1, then the node 102 may proceed to stop. If the node 102 determines that the current code rate being used is greater than or equal to CRTh1, then the node 102 proceeds to operation 212.

At operation 212, in some implementations, the node 102 decreases the current code rate being used by the node 102 for a fourth message 114. The node 102 may decrease the current code rate by a code rate decrease threshold CRDecreaseTh. The node 102 may use the new code rate (current code rate minus CRDecreaseTh) for sending subsequent fourth messages 114 (e.g., to the one or more UE 104-2).

At operation 214, the node 102 determines if the number of third messages 113 received over ThTime is greater than a second threshold value RACHAttTh2, and if a success rate corresponding to a plurality of fourth messages 114 is greater than an upper threshold success rate Xhigh. The first threshold value RACHAttTh2 may specify a minimum number of initial access success attempts to ensure a sufficient sample size for adjusting the fourth message 114 code rate. For example, the second threshold value may be 500. If the node 102 determines that the number of third messages 113 received is less than RACHAttTh2, or if the fourth message 114 success rate is less than or equal to Xhigh, then the node 102 proceeds to operation 206. In some implementations, if the node 102 determines that the number of third messages 113 received is less than RACHAttTh2, or if the fourth message 114 success rate is less than or equal to Xhigh, then the node 102 may proceed to stop. If the node 102 determines that the number of third messages 113 received is greater than or equal to RACHAttTh2 and the fourth message 114 success rate is greater than Xhigh, then the node 102 proceeds to operation 216.

In some implementations, at operation 214, the node 102 determines if the number of first messages 111 received over ThTime is greater than a second threshold value RACHAttTh2, and if a success rate corresponding to a plurality of fourth messages 114 is greater than an upper threshold success rate Xhigh. The first threshold value RACHAttTh2 may specify a minimum number of initial access success attempts to ensure a sufficient sample size for adjusting the fourth message 114 code rate. For example, the second threshold value may be 500. If the node 102 determines that the number of first messages 111 received is less than RACHAttTh2, or if the fourth message 114 success rate is less than or equal to Xhigh, then the node 102 proceeds to operation 206. In some implementations, if the node 102 determines that the number of first messages 111 received is less than RACHAttTh2, or if the fourth message 114 success rate is less than or equal to Xhigh, then the node 102 may proceed to stop. If the node 102 determines that the number of first messages 111 received is greater than or equal to RACHAttTh2 and the fourth message 114 success rate is greater than Xhigh, then the node 102 proceeds to operation 216.

At operation 216, in some implementations, the node 102 determines if a current code rate being used by the node 102 for a fourth message 114 is less than a maximum code rate CRTh2. If the node 102 determines that the current code rate being used is greater than or equal to CRTh2, then the node 102 proceeds to operation 206. In some implementations, if the node 102 determines that the current code rate being used is greater than or equal to CRTh2, then the node 102 may proceed to stop. If the node 102 determines that the current code rate being used is less than CRTh2, then the node 102 proceeds to operation 218.

At operation 218, in some implementations, the node 102 increases the current code rate being used by the node 102 for a fourth message 114. The node 102 may increase the current code rate by a code rate increase threshold CRIncreaseTh. The node 102 may use the new code rate (current code rate+CRIncreaseTh) to send the fourth message(s) 114a to the UE 104-2 (e.g., to a UE among the one or more UE 104-2).

It is understood that, in various embodiments, one or more of the operations in FIG. 2 may be omitted, and/or one or more additional or different operations may be added.

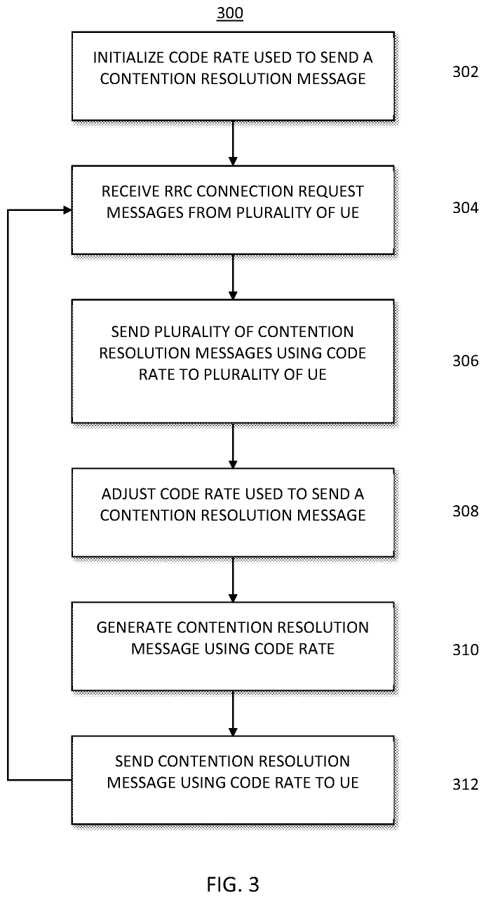

FIG. 3 illustrates a flowchart of a method 300 for performing adaptive optimization of a contention resolution (CR) message, in accordance with one or more example embodiments. Referring to FIG. 3, at operation 302, in some implementations, the node 102 initializes a code rate used to send a CR message (e.g., fourth message 114). The node 102 may initialize the code rate based on one or more predetermined static parameters. For example, the node 102 may initialize the code rate based on a predetermined value set by a network administrator.

At operation 304, in some implementations, the node 102 receives a plurality of RRC connection request messages (e.g., third messages 113) from a plurality of first UE (e.g., the plurality of UE 104-1). The node 102 may receive each of the plurality of RRC connection request messages from a respective one of the plurality of first UE. For example, each UE among the plurality of UE may send a RRC connection request message to the node 102, and the node 102 may receive the connection request messages from each UE. The node 102 may receive the plurality of RRC connection request messages over a threshold time window (e.g., ThTime).

At operation 306, in some implementations, the node 102 sends a plurality of CR messages (e.g., fourth message 114). The node 102 may send the plurality of CR messages using a first code rate (e.g., initialized code rate, previously adjusted code rate). The node 102 may send the plurality of CR messages using the first code rate to the plurality of first UE, in response to receiving the plurality of RRC connection request messages. The node 102 may send each of the plurality of CR messages to a respective one of the plurality of first UE. For example, the node 102 may send a CR message to a UE among the plurality of first UE, in response to receiving a RRC connection request from the UE.

At operation 308, in some implementations, the node 102 adjusts a code rate used to send a CR message. The node 102 may update one or more parameters to adjust the code rate from the first code rate to a second code rate. The node 102 may update the one or more parameters based on a success rate corresponding to the plurality of CR messages using the first code rate that were sent to the plurality of first UE. For example, the node 102 may receive one or more acknowledgement messages from the plurality of first UE. The node 102 may receive each acknowledgement message from a UE among the plurality of first UE in response to the UE receiving a respective one of the plurality of CR messages using the first code rate. The node 102 may determine the success rate corresponding to the plurality of CR messages sent using the first code rate based on a ratio of a number of the one or more acknowledgement messages received to a number of the plurality of RRC connection request messages received from the plurality of first UE. The node 102 may determine whether the number of the plurality of RRC connection request messages received from the plurality of first UE is greater than a first threshold value (e.g., RACHAttTh1). The node 102 may update the one or more parameters to decrease the first code rate to the second code rate if the number of the plurality of RRC connection request messages received from the plurality of first UE is greater than the first threshold value and the determined success rate is less than a lower threshold success rate (e.g., Xlow). The node 102 may determine whether the number of the plurality of RRC connection request messages received from the plurality of first UE is greater than a second threshold value (e.g., RACHAttTh2). The node 102 may update the one or more parameters to increase the first code rate to the second code rate if the number of the plurality of RRC connection request messages received from the plurality of first UE is greater than the second threshold value and the determined success rate is greater than an upper threshold success rate (e.g., Xhigh). The node 102 may decrease the code rate by a code rate decrease threshold amount (e.g., CRDecreaseTh), and the node 102 may increase the code rate by a code rate increase threshold amount (e.g., CRIncreaseTh).

At operation 310, in some implementations, the node 102 generates a CR message (e.g., message 114a). The node 102 may generate the CR message using the adjusted code rate.

At operation 312, in some implementations, the node 102 sends the CR message using the adjusted code rate. The node 102 may send the CR message to a second UE (e.g., a UE among the one or more UE 104-2) in response to receiving a RRC connection request message from the second UE after the threshold time window.

It is understood that, in various embodiments, one or more of the operations in FIG. 3 may be omitted, and/or one or more additional or different operations may be added.

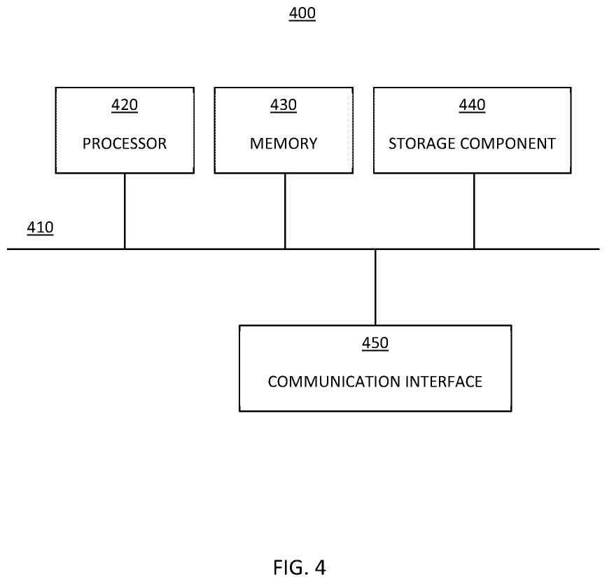

FIG. 4 is a diagram of components of one or more devices according to an example embodiment. Device 400 may correspond to any of the devices described above (e.g., UE, base station, RAN node, core network device implementing core network function).

Referring to FIG. 4, the device 400 may include a bus 410, a processor 420, a memory 430, a storage component 440, and a communication interface 450. It is understood that one or more of the components may be omitted and/or one or more additional components may be included.

The bus 410 includes a component that permits communication among the components of the device 400. The processor 420 is implemented in hardware, firmware, or a combination of hardware and software. The processor 420 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. The processor 420 includes one or more processors capable of being programmed to perform a function.

The memory 430 includes a random access memory (RAM), a read only memory (ROM), and/or another type of dynamic or static storage device (e.g., a flash memory, a magnetic memory, and/or an optical memory) that stores information and/or instructions for use by the processor 420.

The storage component 440 stores information and/or software related to the operation and use of the device 400. For example, the storage component 440 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The communication interface 450 includes a transceiver-like component (e.g., a transceiver and/or a separate receiver and transmitter) that enables the device 900 to communicate with other devices, such as via a wired connection, a wireless connection, or a combination of wired and wireless connections. The communication interface 450 may permit device 400 to receive information from another device and/or provide information to another device. For example, the communication interface 450 may include an Ethernet interface, an optical interface, a coaxial interface, an infrared interface, a radio frequency (RF) interface, a universal serial bus (USB) interface, a Wi-Fi interface, a cellular network interface, or the like.

The device 400 may perform one or more processes or functions described herein. The device 400 may perform operations based on the processor 420 executing software instructions stored by a non-transitory computer-readable medium, such as the memory 430 and/or the storage component 440. A computer-readable medium is defined herein as a non-transitory memory device. A memory device includes memory space within a single physical storage device or memory space spread across multiple physical storage devices.

Software instructions may be read into the memory 430 and/or the storage component 440 from another computer-readable medium or from another device via the communication interface 450. When executed, software instructions stored in the memory 430 and/or storage component 440 may cause the processor 420 to perform one or more processes described herein.

Additionally, or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 4 are provided as an example. In practice, device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

In embodiments, any one of the operations or processes of FIGS. 2 and 3 may be implemented by or using any one of the elements illustrated in FIGS. 1 and 4.

According to example embodiments, RAN node may adaptively optimize a contention resolution (CR) message. For instance, the node may determine a success rate for a plurality of CR messages sent to a plurality of UE (in response to receiving a plurality of RRC connection request messages from the plurality of UE), and update one or more parameters used to determine a code rate for a CR message. The node may update the one or more parameters to adjust the code rate based at least in part on a radio frequency condition of an environment between the node and the plurality of UE, a minimum number of connection attempts (RRC connection request messages), a minimum number of connection attempts over a specified time window, a minimum code rate, a maximum code rate, a code rate increase threshold, and a code rate decrease threshold. The node may adjust the code rate used for CR messages as the radio frequency condition of the environment changes over time. As a result, resources used for communication between the node and a UE may be utilized with greater efficiency and less waste.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium may be a tangible device that may retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that may direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. A method for adaptively optimizing a contention resolution (CR) message by a radio access network (RAN) node, the method comprising:
receiving a plurality of radio resource control (RRC) connection request messages from a plurality of first user equipment (UE), wherein each of the plurality of RRC connection request messages is received from a respective one of the plurality of first UE;
sending a plurality of CR messages using a first code rate to the plurality of first UE, in response to receiving the plurality of RRC connection request messages from the plurality of first UE, wherein each of the plurality of CR messages is sent to a respective one of the plurality of first UE;
updating one or more parameters to adjust the first code rate to a second code rate, based on a success rate corresponding to the plurality of CR messages using the first code rate;
generating a CR message using the second code rate; and
sending the CR message using the second code rate to a second UE.

2. The method of claim 1, wherein updating the one or more parameters to adjust the first code rate to the second code rate based on the success rate corresponding to the plurality of CR messages using the first code rate comprises:
receiving one or more acknowledgement messages, each acknowledgement message being received from a UE among the plurality of first UE in response to the UE receiving a respective one of the plurality of CR messages using the first code rate;
determining the success rate corresponding to the plurality of CR messages using the first code rate based on a ratio of a number of the one or more acknowledgement messages received to a number of the plurality of RRC connection request messages received from the plurality of first UE; and
updating the one or more parameters to adjust the first code rate to the second code rate based on the determined success rate.

3. The method of claim 2, wherein updating the one or more parameters to adjust the first code rate to the second code rate based on the determined success rate comprises:
determining whether the number of the plurality of RRC connection request messages received from the plurality of first UE is greater than a first threshold value; and
updating the one or more parameters to decrease the first code rate to the second code rate in response to determining that the number of the plurality of RRC connection request messages received from the plurality of first UE is greater than the first threshold value and the determined success rate is less than a lower threshold success rate.

4. The method of claim 3, wherein the first code rate is decreased by a code rate decrease threshold amount.

5. The method of claim 2, wherein updating the one or more parameters to adjust the first code rate to the second code rate based on the determined success rate comprises:
determining whether the number of the plurality of RRC connection request messages received from the plurality of first UE is greater than a second threshold value; and
updating the one or more parameters to increase the first code rate to the second code rate in response to determining that the number of the plurality of RRC connection request messages received from the plurality of first UE is greater than a second threshold value and the determined success rate is greater than an upper threshold success rate.

6. The method of claim 5, wherein the first code rate is increased by a code rate increase threshold amount.

7. The method of claim 1, wherein the plurality of RRC connection request messages from the plurality of first UE are received over a threshold time window, and
wherein the CR message using the second code rate is generated in response to receiving a RRC connection request message from the second UE after the threshold time window.

8. An apparatus for performing adaptive optimization of a contention resolution (CR) message by a radio access network (RAN) node, the apparatus comprising:
a memory storing instructions; and
at least one processor configured to execute the instructions to:
receive a plurality of radio resource control (RRC) connection request messages from a plurality of first user equipment (UE), wherein each of the plurality of RRC connection request messages is received from a respective one of the plurality of first UE;
send a plurality of CR messages using a first code rate to the plurality of first UE, in response to receiving the plurality of RRC connection request messages from the plurality of first UE, wherein each of the plurality of CR messages is sent to a respective one of the plurality of first UE;
update one or more parameters to adjust the first code rate to a second code rate, based on a success rate corresponding to the plurality of CR messages using the first code rate;
generate a CR message using the second code rate; and
send the CR message using the second code rate to a second UE.

9. The apparatus of claim 8, wherein the instructions to update the one or more parameters to adjust the first code rate to the second code rate based on the success rate corresponding to the plurality of CR messages using the first code rate further comprise instructions to:
receive one or more acknowledgement messages, each acknowledgement message being received from a UE among the plurality of first UE in response to the UE receiving a respective one of the plurality of CR messages using the first code rate;
determine the success rate corresponding to the plurality of CR messages using the first code rate based on a ratio of a number of the one or more acknowledgement messages received to a number of the plurality of RRC connection request messages received from the plurality of first UE; and
update the one or more parameters to adjust the first code rate to the second code rate based on the determined success rate.

10. The apparatus of claim 9, wherein the instructions to update the one or more parameters to adjust the first code rate to the second code rate based on the determined success rate further comprise instructions to:
determine whether the number of the plurality of RRC connection request messages received from the plurality of first UE is greater than a first threshold value; and
update the one or more parameters to decrease the first code rate to the second code rate in response to a determination that the number of the plurality of RRC connection request messages received from the plurality of first UE is greater than the first threshold value and the determined success rate is less than a lower threshold success rate.

11. The apparatus of claim 10, wherein the first code rate is decreased by a code rate decrease threshold amount.

12. The apparatus of claim 9, wherein the instructions to update the one or more parameters to adjust the first code rate to the second code rate based on the determined success rate further comprise instructions to:
determine whether the number of the plurality of RRC connection request messages received from the plurality of first UE is greater than a second threshold value; and
update the one or more parameters to increase the first code rate to the second code rate in response to a determination that the number of the plurality of RRC connection request messages received from the plurality of first UE is greater than a second threshold value and the determined success rate is greater than an upper threshold success rate.

13. The apparatus of claim 12, wherein the first code rate is increased by a code rate increase threshold amount.

14. The apparatus of claim 8, wherein the plurality of RRC connection request messages from the plurality of first UE are received over a threshold time window, and
wherein the CR message using the second code rate is generated in response to receiving a RRC connection request message from the second UE after the threshold time window.

15. A non-transitory computer-readable medium for storing computer readable program code or instructions for carrying out operations, when executed by a processor, for adaptive optimization of a contention resolution (CR) message, the operations comprising:
receiving a plurality of radio resource control (RRC) connection request messages from a plurality of first user equipment (UE), wherein each of the plurality of RRC connection request messages is received from a respective one of the plurality of first UE;
sending a plurality of CR messages using a first code rate to the plurality of first UE, in response to receiving the plurality of RRC connection request messages from the plurality of first UE, wherein each of the plurality of CR messages is sent to a respective one of the plurality of first UE;
updating one or more parameters to adjust the first code rate to a second code rate, based on a success rate corresponding to the plurality of CR messages using the first code rate;
generating a CR message using the second code rate; and
sending the CR message using the second code rate to a second UE.

16. The non-transitory computer-readable medium of claim 15, wherein updating the one or more parameters to adjust the first code rate to the second code rate based on the success rate corresponding to the plurality of CR messages using the first code rate comprises:
receiving one or more acknowledgement messages, each acknowledgement message being received from a UE among the plurality of first UE in response to the UE receiving a respective one of the plurality of CR messages using the first code rate;
determining the success rate corresponding to the plurality of CR messages using the first code rate based on a ratio of a number of the one or more acknowledgement messages received to a number of the plurality of RRC connection request messages received from the plurality of first UE; and
updating the one or more parameters to adjust the first code rate to the second code rate based on the determined success rate.

17. The non-transitory computer-readable medium of claim 16, wherein updating the one or more parameters to adjust the first code rate to the second code rate based on the determined success rate comprises:
determining whether the number of the plurality of RRC connection request messages received from the plurality of first UE is greater than a first threshold value; and
updating the one or more parameters to decrease the first code rate to the second code rate in response to determining that the number of the plurality of RRC connection request messages received from the plurality of first UE is greater than the first threshold value and the determined success rate is less than a lower threshold success rate.

18. The non-transitory computer-readable medium of claim 16, wherein updating the one or more parameters to adjust the first code rate to the second code rate based on the determined success rate comprises:
determining whether the number of the plurality of RRC connection request messages received from the plurality of first UE is greater than a second threshold value; and
updating the one or more parameters to increase the first code rate to the second code rate in response to determining that the number of the plurality of RRC connection request messages received from the plurality of first UE is greater than a second threshold value and the determined success rate is greater than an upper threshold success rate.

19. The non-transitory computer-readable medium of claim 15, wherein the plurality of RRC connection request messages from the plurality of first UE are received over a threshold time window, and
wherein the CR message using the second code rate is generated in response to receiving a RRC connection request message from the second UE after the threshold time window.

20. The non-transitory computer-readable medium of claim 15, wherein the operations further comprise:
generating a plurality of CR messages using the second code rate; and
sending the plurality of CR message using the second code rate to a plurality of second UE, wherein each of the plurality of CR messages using the second code rate is sent to a respective one of the plurality of second UE.
